(19) United States
(12) Patent Application Publication
(10) Pub. No.: US 2003/0044557 A1
(43) Pub. Date: Mar. 6, 2003

(54) Composite packaging material having a base layer of paper and an attached tubular sleeve envelope of plastic material, particularly for food products

(76) Inventor: Luigi Rivoltella, Giovanni Reatino (IT)

Correspondence Address: SMITH, GAMBRELL & RUSSELL, LLP, 1850 M STREET, N.W., SUITE 800, WASHINGTON, DC, 20036, US

(21) Appl. No.: 10/206,865

(22) Filed: Jul. 29, 2002

Related U.S. Application Data
(63) Continuation of application No. 09/613,810, filed on Jul. 11, 2000, now abandoned.

(30) Foreign Application Priority Data
Jul. 12, 1999 (IT) RM99U000158

(51) Int. Cl. B32B 1/08

(52) U.S. Cl. 428/36.91

(57) ABSTRACT

Subject matter of this invention is a composite double component packaging material, particularly for food products, comprising first component (10), consisting of a base sheet of paper material, upon which a second component (11) formed by a tubular sleeve of a thin film of plastics material is adhered, of a kind approved for use with food products.

This invention broadly relates to packaging materials and more particularly concerns a composite, double component, paper based packaging material, specifically useful for packaging food products.

Even if it should be understood that no restrictive use limitation is to be derived from the following specification, the specific field of use of the packaging material according to this invention is the field of the retail sale of food products, particularly single piece and discrete products, such as bacon, cheese, meats, dairy products and like.

As it is well known, as a consequence of an already established general practice and in compliance with always more and more restrictive and binding hygienical regulations, food products offered for retail sale to public are packaged in wrappings consisting of sheets of paper based material which are wrapped around the product.

The packaging of paper based material should fulfill well established hygiene and safety requirements, so that it has been for a certain time and presently it is still general practice to use composite wrappings comprising a paper based sheet, intended not to contact the food product, together with a thin film of a plastics material complying with the legal hygiene and use safety regulations and requirements.

Such wrappings, however, have at least a deficiency. In fact, aiming at preventing, during the wrapping operation, which very often entails a real rolling of the paper based material together with the food product contained therein, often consisting of a number of thin wafers, the concerned food product from contacting the external paper based material, it is usual practice to use a second sheet of plastics material to directly cover the concerned food product, so that, even is said packaging material is to be very tightly wrapped, the concerned food product is always insulated and separated from the external paper based layer.

Even if it is certainly efficient, this approach always entails use of two materials of different kinds, with consequent problems for storage, inventory, separate housing compartments and like. Furthermore, handling of said materials entails an increased risk of contamination of the surfaces contacting the concerned food product.

It is an object of this invention to improve such kind of packaging materials and to realize a composite double component packaging material which can be easy to be manufactured, as well as easy to be stored and applied, while providing at once better performances than those offered by conventional packagings, even the most recently developed ones.

It is specific subject-matter of this invention, therefore, a composite double component packaging material, particularly for food products, comprising a first component acting as a support paper base layer, upon which a second component is adhered, consisting of a tubular sleeve made by a thin film of a material hygienically acceptable for contact with food products, wherein said tubular sleeve of thin film of hygienically acceptable material has sizes not larger and preferably smaller than the sizes of said base layer, so that, once the product to be packaged is inserted into said tubular sleeve, the assembly can be rolled or folded while the base paper sheet is outwardly maintained, with full and complete guarantee that, whichever rolling or folding operation is carried out, the packaged food product only and exclusively contacts the inner surface of the tubular sleeve and never contacts its external surface and even less it contacts the paper base sheet.

Further details and advantages of this invention will be apparent from the following description with reference to the annexed drawings in which the preferred embodiment is shown by way of illustration and not by way of limitation.

In the drawings:

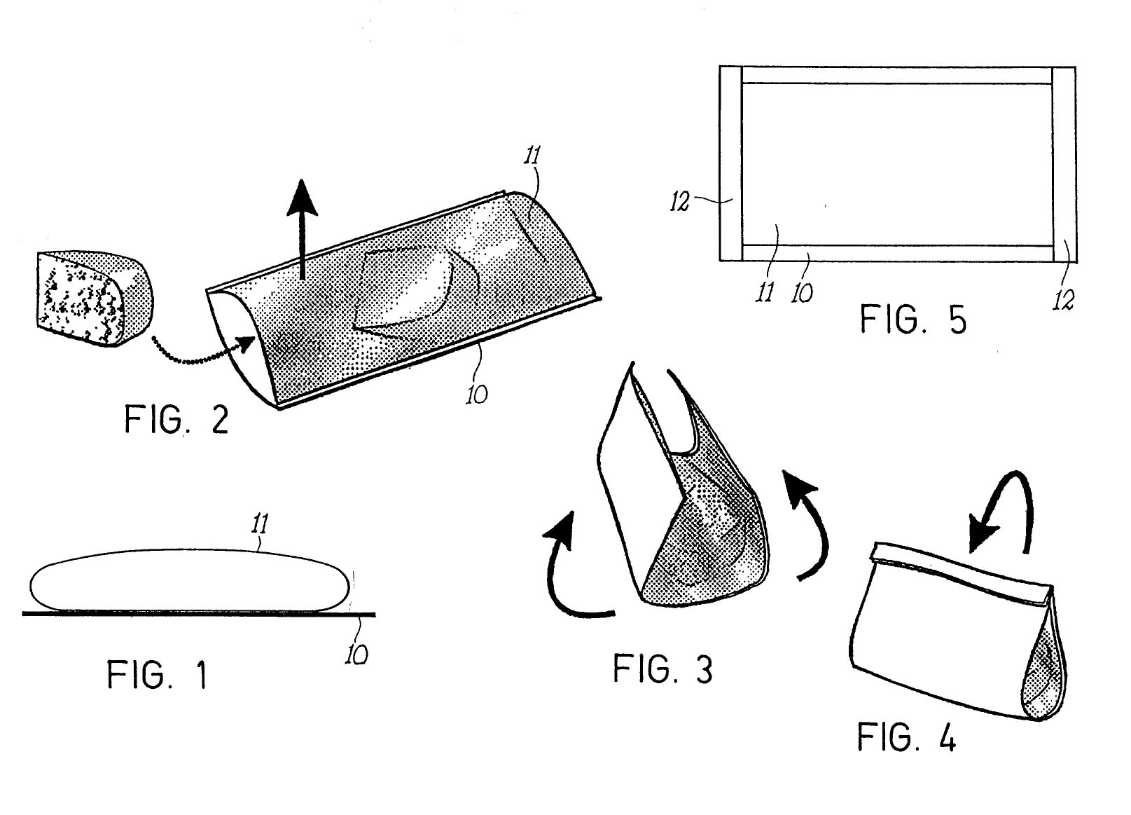

FIG. 1 is a cross-section view of a composite double component packaging sheet material according to this invention,

FIG. 2 is a perspective view of a composite double component packaging sheet material with the tubular sleeve in partially open condition, in order to show how the product is inserted therein,

FIG. 3 is a perspective view of a package containing a food product while it is being folded,

FIG. 4 shows the final stage of the folding sequence of the package of FIG. 3, in which the open flaps are hermetically sealed,

FIG. 5 is a plan top view of a different embodiment having two longitudinal flaps adapted to be glued.

By referring now to FIG. 1 of the drawings, the main embodiment of this invention comprises a first component 10, consisting of a base sheet of paper material, upon which a second component 11 formed by a tubular sleeve of a thin film of plastics material is applied, of a kind approved for use with food products, , for instance by gluing. Said tubular sleeve 11 is made of polyethylene or similar, manufactured by conventional extrusion methods, and it is also adhered to the paper base sheet 10 by means of conventional methods and equipment.

The characterizing feature of said thin film tubular sleeve 11, however, is that, for convenience of use and for functionality reasons, it has transversal sizes not larger than the base sheet 10 and particularly it can be narrower than said base sheet 10, so as to leave a certain free edge on one or on both sides. Upon introducing the concerned food product into said sleeve, it is retained in covered and protected condition and the upper flap of the sleeve performs the same function as performed by a second separate overposed sheet of plastics material according to the present state of the art.

By referring to FIG. 2 of the drawings, the initial step for use of said packaging material is shown, in which the upper flap of the tubular sleeve 11 is slightly lifted so as to introduce the food product thereinto.

FIG. 3 shows the subsequent step for use in which the package is folded. The folding mode is self-explaining, but it should be understood that the folding step can also be carried out as a rolling step and that such folding or rolling step can also be performed in a different direction with respect to the illustrated one, without so departing from the scope of this invention.

By referring to FIG. 4, it can be observed that the simplest procedure for hermetically closing the package provides that the longitudinal flaps be folded. In this respect, however, the possibility is to be mentioned for the tubular sleeve 11 to have longitudinal dimensions even smaller than the dimensions of the base sheet 10, so as to leave one or two free longitudinal edges 12 of the base sheet. Such free edges 12 can be provided with suitable glue stripes, for instance a pressure responsive adhesive, so as to make the hermetical closure operation of the package more immediate and certain, as already illustrated in FIG. 4, such pressure responsive adhesive glue stripes being also adapted to be protected before use by detachable cover strips, so as to activate the gluing effect only at the desired time.

As above mentioned, the adhesion between the base sheet and the thin plastics material tubular sleeve overposed thereupon can be effected by means of any desired method and equipment, but anyway it is suggested that the adhesion be not extended to the whole contact surface, so as to leave a not adherent peripheral edge designed to aid lifting of the upper flap of the sleeve.

The package according to this invention enables a more prolonged storage of the food product contained therein and eliminates any possibility for the operator, for instance the servant at a astronomy bench, to contact the inner surface of the packaging sleeve, thereby assuring the possibility to handle the package as a whole with no risk whatsoever of hygienic contamination. Furthermore, the extremely easy procedure to be followed to close the package by a simple folding operation with possible optional adhesion of its longitudinal edges enables the consumer to re-use the package or if desired only its tubular sleeve for disposal of any resulting residuals.

The preferred embodiments of this invention have been heretofore described, but it should be expressly understood that those skilled in the art can make changes and modifications to the details and to the material compositions, as well as to the thicknesses and the shapes, without departing from the scope of this invention as defined in the annexed claims.

1. A composite double component packaging material, particularly for food products, comprising first component (10), consisting of a base sheet of paper material, upon which a second component (11) formed by a tubular sleeve of a thin film of plastics material is adhered, of a kind approved for use with food products.

2. A composite packaging material according to claim 1, characterized in that said thin film tubular sleeve (11) has transversal sizes not larger than the base sheet (10) and particularly it can be narrower than said base sheet (10), so as to leave a free edge on one or on both sides.

3. A composite packaging material according to claim 1, characterized in that the adhesion between the base sheet (10) and the overposed tubular film sleeve (11) is extended to less than their whole contact surface, in order to leave a not adherent peripheral edge to aid opening of said tubular sleeve (11) by lifting its upper flap.

4. A composite packaging material according to claim 3, characterized in that said tubular sleeve (11) has longitudinal dimensions smaller than the base sheet (10), so as to leave one or two free longitudinal edges (12) of the base sheet and said one or both longitudinal edges (12) can be provided with suitable glue stripes, for instance a pressure responsive adhesive, possibly protected before use by detachable cover strips, so as to make the hermetical closure operation of the package more immediate and certain.

5. A composite double component packaging material, particularly for food products, according to any one of the preceding claims and substantially as described in the specification and shown in the annexed drawings.
